(19) United States
(12) Patent Application Publication
(10) Pub. No.: US 2026/0322608 A1
(43) Pub. Date: Oct. 15, 2026

(54) GOVERNANCE RECORD GENERATION METHOD FOR NON-DETERMINISTIC PROCESSING SYSTEMS

(71) Applicant: Chih-Wei Huang, Tainan City (TW)

(72) Inventor: Chih-Wei Huang, Tainan City (TW)

(21) Appl. No.: 19/571,528

(22) Filed: Mar. 19, 2026

(51) Int. Cl. H04L 9/32

(52) U.S. Cl. CPC H04L 9/3218; H04L 9/3236

(57) ABSTRACT

A governance record generation method for a Non-Deterministic Processing System is disclosed. Upon receiving a Governance Initiation Command, the system generates an Initiation Identifier and performs Input Structuring Processing on Input Data to produce Structured Segmented Data without altering semantic content. A Unified Trace Identifier is generated to maintain cross-step linkage throughout the governance session. After the Input Data is submitted to the Non-Deterministic Processing System and NDP Output Data is obtained, the system encapsulates the output with Governance Metadata into a Governance Archival Unit. Each Governance Archival Unit is cryptographically linked to form an immutable archival sequence, ensuring traceability. The governance records support Multi-Step Inference Sequences, concurrent inference, and Multi-Agent Collaborative Inference, generating a verifiable Termination State to enable verification, replay, and Contextual Replay Reconstruction.

### CROSS REFERENCE TO RELATED APPLICATIONS

This application claims the benefit of and priority under 35 U.S.C. § 119 to Taiwan Patent Application No. 114145972, filed on Nov. 25, 2025, the entire disclosure of which is incorporated herein by reference.

### FIELD OF INVENTION

The present disclosure generally relates to governance technologies applicable to a

Non-Deterministic Processing System, and more particularly, to a method for generating verifiable governance records during an inference process. Through procedures such as the generation of an Initiation Identifier, the derivation of a Unified Trace Identifier, Input Structuring Processing, the encapsulation of NDP Output Data, and Cryptographic Linking, the method ensures that data associated with the Non-Deterministic Processing System during a governance period possesses consistency, traceability, and immutability. Furthermore, the method supports the governance requirements of Multi-Step Inference Sequences, concurrent inference flows, and Multi-Agent Collaborative Inference flows.

### BACKGROUND OF INVENTION

With the rapid proliferation of generative artificial intelligence (as an example of a Non-Deterministic Processing System) across enterprise, legal, regulatory, and critical infrastructure domains, there is a significantly increasing market demand for interaction audit trails that are immutable, verifiable, and replayable. Such audit trails are fundamental for regulatory compliance, forensic analysis, risk management, and the establishment of interaction non-repudiation. However, existing technologies fail to provide the integrated governance capabilities required for interactions with a Non-Deterministic Processing System, particularly in aspects such as session initiation governance, semantically consistent Input Structuring Processing, cryptographic archiving, cross-step inference linking, role correspondence verification, and complete Contextual Replay Reconstruction. While some conventional technologies disclose individual components, they are collectively insufficient to form the end-to-end archiving and verification architecture required by the present disclosure.

Limitations of Existing Data Audit and Provenance Technologies: Conventional data auditing and provenance tracking systems are primarily applied to data pipelines or IT event logging. These technologies typically center on static data versions, event timestamps, and data flows, and do not perform archiving and verifiable linking for the dynamic inference processes of generative artificial intelligence (exemplified as a Non-Deterministic Processing System). They lack the following essential elements of the present disclosure: (1) an initiation hash value at the session initiation stage; (2) a persistent Unified Trace Identifier; (3) semantics-preserving Input Structuring Processing; (4) Governance Archival Units for multi-turn inferences; and (5) Contextual Replay Reconstruction capabilities with role correspondence consistency.

Limitations of U.S. Patent Application Publication No. 2022/0207386A1: U.S. Patent Publication No. 2022/0207386 A1 discloses a “Data Confidence Fabric (DCF)” architecture that utilizes an immutable ledger to record data events and a unique identifier to track data provenance. The architecture can establish a “Digital Twin” via temporal linking to trace back data states. However, its limitations include: (1) its design objective is directed to data event auditing, rather than generative AI interactions; (2) it fails to disclose the initiation of an archiving session triggered by an external Governance Initiation Command; (3) it does not provide cryptographic binding between an initiation hash value and a Unified Trace Identifier; (4) it lacks the structure of a Governance Archival Unit for multi-turn inferences; and (5) it lacks a role correspondence or contextual consistency verification mechanism.

Limitations of U.S. Patent Application Publication No. 2017/0237553A1: U.S. Patent Publication No. 2017/0237553 A1 teaches a method of using cryptographic serialization to form an immutable provenance chain for data objects and their source information. Its limitations are: (1) it is only applicable to general digital data objects; (2) it fails to disclose semantics-preserving Input Structuring Processing; (3) it does not involve the archiving of generative AI inference steps; (4) it lacks a session-level Unified Trace Identifier and initiation hash linking; and (5) it lacks cross-step Contextual Replay Reconstruction capability.

Limitations of U.S. Pat. No. 11,709,819B2: U.S. Pat. No. 11,709,819 B2 discloses an architecture for verifying test results and test artifacts using a blockchain, making them immutable and verifiable. However, it is limited to test data verification and fails to disclose: (1) the archiving of inference flows of a Non-Deterministic Processing System; (2) an initiation process triggered by an external Governance Initiation Command; (3) a session-level Unified Trace Identifier; (4) multi-turn inference contexts; and (5) role correspondence consistency replay.

Limitations of U.S. Patent Application Publication No. 2022/0141034A1: U.S. Patent Publication No. 2022/0141034 A1 provides provenance at the data distribution level by tracking data sources and distribution history using cryptographic tokens. Its limitations are: (1) it lacks the archiving of generative AI interactions; (2) it lacks semantics-preserving Input Structuring Processing; (3) it lacks cross-step inference Governance Archival Units; (4) it lacks initiation hash linking driven by an external governance intent; and (5) it lacks a complete Contextual Replay Reconstruction mechanism.

Limitations of Enterprise Multi-Tenant Logging Architectures (e.g., U.S. Pat. No. 8,713,693B2): As shown in U.S. Pat. No. 8,713,693 B2 (Salesforce), multi-tenant logging architectures primarily address log isolation and access security across tenants and customers, aiming at log management for cloud services. However, it fails to disclose: (1) cryptographic Governance Archival Units; (2) linking between a Unified Trace Identifier and an initiation hash; (3) multi-turn inference Contextual Replay Reconstruction; (4) an interaction archiving architecture for a Non-Deterministic Processing System; and (5) role correspondence consistency replay.

Overall Deficiencies of the Prior Art: In summary, even if an attempt is made to combine the aforementioned conventional technologies (e.g., forcibly splicing a data audit ledger system with software event replay technology), they cannot form the generative AI governance architecture required by the present disclosure due to the fundamental differences in data types, operational mechanisms, and technical objectives. Specifically, the prior art neither discloses nor suggests essential mechanisms such as “randomness seed control” for non-deterministic inference, “semantics-preserving mapping of Input Structuring Processing,” or “cross-step inference reconstruction with human-readable context.” Furthermore, the prior art does not teach cryptographically embedding a governance initialization intent into the lifecycle of a Unified Trace Identifier.

Crucially, during the initiation stage, the present disclosure does not assign an arbitrary identifier. Instead, an initiation hash value is derived from a Governance Initiation Command via cryptographic operations, serving as the anchoring baseline for the Unified Trace Identifier. This ensures that all subsequent Governance Archival Units are continuously linked under the same governance session. This archiving lifecycle design—proceeding from “governance intent” to “hash derivation,” to “Unified Trace Identifier,” and finally to “Governance Archival Unit linking”—has never been disclosed, suggested, or reasonably deducible from existing data auditing architectures, general data provenance tracking systems, blockchain verification technologies, or software event replay technologies.

Therefore, existing technologies cannot achieve the end-to-end verifiable governance capabilities provided by the present disclosure, nor can they provide the integrated archiving architecture required to execute role correspondence consistency verification during the replay process. The overall technical combination of the present disclosure exhibits distinct differences and effectively overcomes the inherent limitations of the related art.

### SUMMARY OF THE INVENTION

Upon receiving a Governance Initiation Command, the system initiates a verifiable archiving session using the command as an external governance command. The Governance Initiation Command may include one or more parallel control commands.

In response to the Governance Initiation Command, the system generates a unique session-level Unified Trace Identifier. The Unified Trace Identifier embeds an Initiation Identifier hash calculated from the Governance Initiation Command to cryptographically bind the archiving session to the Governance Initiation Command.

The system further executes Input Structuring Processing and Governance Archival Unit generation logic to encapsulate interaction data into one or more Governance Archival Units. Each Governance Archival Unit is associated with the Unified Trace Identifier via Cryptographic Linking, and supports the verification of Agent Role Identifiers and Contextual Replay Reconstruction in subsequent replay procedures.

In some embodiments, the system is deployed as a non-intrusive middleware, independent of the internal parameters and inference architecture of the Non-Deterministic Processing System, to maintain technological neutrality and support persistent governance sessions.

In other embodiments, the system may also be integrated through various deployment forms and user interaction interfaces, including a SaaS-based front-end interface, an API integration mode, an enterprise internal inference agent, an input interface for image or text generation, a plug-in governance layer for cloud inference services, or an embedded Edge deployment environment. The aforementioned deployment forms are all centered on providing the injection of governance prompt commands, the Input Structuring Processing of Input Data, the governance archiving of NDP Output Data, and cross-step tracking identification linking, without relying on a specific model architecture, inference framework, or service platform.

### BRIEF DESCRIPTION OF DRAWINGS

To provide a clearer description of the technical contents and the accompanying drawings of the present disclosure, a brief description of each drawing is provided below. The drawings of the present disclosure are for illustrative purposes only, to assist in understanding the structure and operational flow of the present disclosure, and are not intended to limit the scope of the present disclosure. The reference numerals and names of elements shown in the drawings correspond to the descriptions provided herein; components with the same or similar functions are denoted by the same reference numerals across different drawings.

FIG. 1 is a schematic diagram illustrating the main body of the governance flow of the present disclosure, showing the governance initiation, input data processing, and Governance Archival Unit generation procedures according to claims 1(a), 1(b), and 1(c). The figure illustrates the overall processing flow of receiving a Governance Initiation Command (100), generating an Initiation Identifier (102), generating Structured Segmented Data from Input Data (104), receiving NDP Output Data (106), and encapsulating it into a Governance Archival Unit (108).

FIG. 2 is a schematic diagram illustrating the logic of Input Structuring Processing of the present disclosure. The figure shows receiving Input Data (200), generating a canonical index (202), generating a serialized indicator (204), establishing a segment index (206), and merging the aforementioned processing results to form Structured Segmented Data (208).

FIG. 3 is a schematic diagram illustrating the derivation logic of the Unified Trace Identifier of the present disclosure. The figure shows obtaining an Initiation Identifier (300), and determining whether to directly adopt the identifier as the Unified Trace Identifier (302), or to first execute cryptographic operations based on the identifier (304) to generate the Unified Trace Identifier (306).

FIG. 4 is a schematic diagram illustrating the Governance Archival Unit Data Structure of the present disclosure. The figure shows the internal fields of the Governance Archival Unit (400), including a Unified Trace Identifier (402), Structured Data (404), NDP Output Data (406), Governance Metadata (408), and a Cryptographic Proof (410).

FIG. 5 is a schematic diagram illustrating the flow of Cryptographic Linking of the present disclosure. The figure shows obtaining Governance Archival Unit data (500), calculating a hash value (502), forming a hash link or Merkle root (504), generating a Cryptographic Proof (506), and writing the proof into the Governance Archival Unit (508).

FIG. 6 is a schematic diagram illustrating the archiving flow of a Multi-Step Inference Sequence of the present disclosure. The figure shows inferring the input and output of step 1 (600) and generating a first Governance Archival Unit (602), followed by inferring steps 2, 3, and 4 (604, 608, 612) and respectively generating corresponding Governance Archival Units (606, 610, 614), forming a complete Multi-Step Inference Sequence linked through the Unified Trace Identifier.

FIG. 7 is a schematic diagram illustrating the classification of Behavioral Outcomes and the archiving flow of a Termination State of the present disclosure. The figure shows that after obtaining a Behavioral Outcome (700), the system sequentially determines a successful output (702), an empty response (704), an abnormal output (706), an error state (708), a timeout state (710), or a crash signal (712), and encapsulates it into a Governance Archival Unit (714). Subsequently, it determines a Termination State (716), which may be normal completion (718), premature termination (720), external interruption (722), timeout termination (724), or incomplete status due to exception (726), and encapsulates it into a Governance Archival Unit of the Termination State (728).

FIG. 8 is a schematic diagram illustrating the architecture of Multi-Agent Collaborative Inference of the present disclosure. The figure shows a multi-agent inference environment (800), including a planning agent (801), a research agent (802), a critique agent (803), and a summary agent (804), where Sequential Linking Information (810, 812, 814) indicates the inference sequence, and data is provided by an input source (830). The inference results of each Agent Model are respectively encapsulated into corresponding Governance Archival Units (842, 844, 846, 848), and a final inference result (820) is output.

### DETAILED DESCRIPTION OF INVENTION

To ensure the clarity, consistency, and legal support of the present specification and the claims, the primary terms are defined herein. The following definitions are for illustrative purposes only and are not intended to be limiting.

“Non-Deterministic Processing System” refers to a computing system whose output results under the same input conditions may exhibit variable characteristics due to factors such as model architecture, inference randomness, environmental state differences, external tool invocations, or serialization factors. Such systems include generative artificial intelligence models, multi-agent inference systems, inference engines with stochastic parameters, or other processing environments with uncertain output results.

“Governance Initiation Command” refers to an explicit command used to initiate a governance session or an equivalent governance processing period, including proactive user operations, system flow events, or external trigger actions, in order to establish a starting baseline for the governance period and drive the generation of an Initiation Identifier.

“Initiation Identifier” refers to a unique identifier used to indicate the starting state of a governance session when a Governance Initiation Command is triggered. It can also serve as the direct basis or the cryptographic derivation source for a subsequent Unified Trace Identifier.

“Input Data” refers to data received during a governance session, including user input data, application-generated data, external event data, or data generated by agent programs, which will serve as the object of subsequent Input Structuring Processing.

“Input Structuring Processing” refers to a processing flow that establishes a canonical index, a serialized indicator, or Governance Metadata for data without altering the semantic content of the Input Data, enabling the data to undergo consistent comparison during governance verification or replay.

“Structured Segmented Data” refers to a tokenized data unit formed through Input Structuring Processing, rendering it comparable and consistent during archiving, verification, and Contextual Replay Reconstruction.

“Structured Data” refers to a collection of governance record data formed during a governance session through Input Structuring Processing, data index establishment, Governance Metadata generation, or other data organizing procedures for governance purposes. The data collection includes a canonical input, a serialized input, an input index, a timestamp (timestamp_utc), and Governance Metadata capable of supporting governance verification, step linking, Contextual Replay Reconstruction, or auditing purposes. Structured Data is used solely for governance verification, archival linking, and consistent comparison procedures; it does not alter the semantic content of the Input Data, nor does it intervene in the inference operations of the Non-Deterministic Processing System.

“Unified Trace Identifier” refers to the core identification key used throughout the lifecycle of a governance session to maintain cross-step linking consistency. It may directly adopt the Initiation Identifier or a cryptographic derivation result based on the Initiation Identifier, and is used to link all governance data, Governance Archival Units, and behavioral context information.

“Governance Archival Unit” refers to a data unit that integrates and encapsulates Structured Segmented Data, NDP Output Data, and Governance Metadata, and is associated with the Unified Trace Identifier via Cryptographic Linking, endowing it with source verifiability and immutability during governance verification.

“NDP Output Data” refers to the output content generated by the Non-Deterministic Processing System during a governance session, including inference responses, returned results from external tools, or results of Multi-Agent Collaborative Inference, serving as the data source for subsequent archiving and replay procedures.

“Cryptographic Linking” refers to utilizing a hash value, a hash chain, a Merkle root, or a combination thereof, to establish an irreversible linking association between a Governance Archival Unit and a Unified Trace Identifier, enabling the archived data to undergo completeness verification and immutability checks at any stage.

“Governance Metadata” refers to behavioral context data generated during a governance session, including step identifiers, tool invocation parameters, external sub-process identifications, inference bases, Agent Model role information, or other data capable of supporting inference reconstruction.

“Multi-Step Inference Sequence” refers to a chain of inference steps formed sequentially or concurrently during a governance session. Cross-step links are established through the Unified Trace Identifier, enabling the complete inference path to be entirely reconstructed during subsequent governance verification or behavioral replay.

“Behavioral Outcome” refers to the state exhibited by the Non-Deterministic Processing System during the governance period, including types such as successful output, empty response, abnormal output, error state, timeout state, or crash signal.

“Termination State” refers to the final state exhibited by a governance session at its last stage, including normal completion, premature termination, external interruption, timeout termination, or incomplete status due to exception events.

“Governance Archival Unit Data Structure” refers to the field structure required to store a Governance Archival Unit within a system environment, including fields such as the Unified Trace Identifier, Structured Input Data, NDP Output Data, Governance Metadata, and a Cryptographic Proof, to support the storage, verification, and replay of archived data.

“Cryptographic Proof” refers to at least one cryptographic hash, linking proof, or Merkle root calculated based on the internal data of a Governance Archival Unit, used to provide technical corroboration of source completeness and immutability during a verification procedure.

“Agent Model” refers to a model instance capable of independently executing inferences, subtasks, or external tool invocations within a Multi-Agent Collaborative Inference environment. Each Agent Model possesses its own role identification, input source, and inference steps, allowing them to be separately recorded in Governance Archival Units to support inference path tracing.

“Sequential Linking Information” refers to identification information describing the sequence, sources, dependencies, and linking methods between inference steps. This information is used to support subsequent inference replay, behavioral verification, and complete Contextual Replay Reconstruction, making the multi-step inference structure of a governance session traceable.

“Agent Role Identifier” refers to identification information used to indicate the role played by an individual Agent Model in a multi-step inference or collaborative environment, including its assigned tasks, responsibility boundaries, or inference stages, to facilitate subsequent role-level behavioral context reconstruction by the Governance Archival Units.

“Tool Invocation Information” refers to identification information recording external tools, functions, or services invoked by the Non-Deterministic Processing System during inference, including tool names, invocation parameters, returned data, and their execution times, to support the complete verification of the inference dependency chain.

“Contextual Replay Reconstruction” refers to utilizing the Unified Trace Identifier, Sequential Linking Information, Governance Metadata, and Governance Archival Unit content to reconstruct the inference context within a governance session, enabling an external verifier to replay, analyze, and conduct consistency verification on the entire behavioral sequence in a subsequent period.

“Multi-Agent Collaborative Inference” refers to an inference procedure jointly executed by multiple Agent Models in a sequential, concurrent, or hybrid manner. Its input sources, Agent Role Identifiers, behavioral sequences, and linking information will be recorded in Governance Archival Units to ensure the traceability and verifiability of the inference procedure.

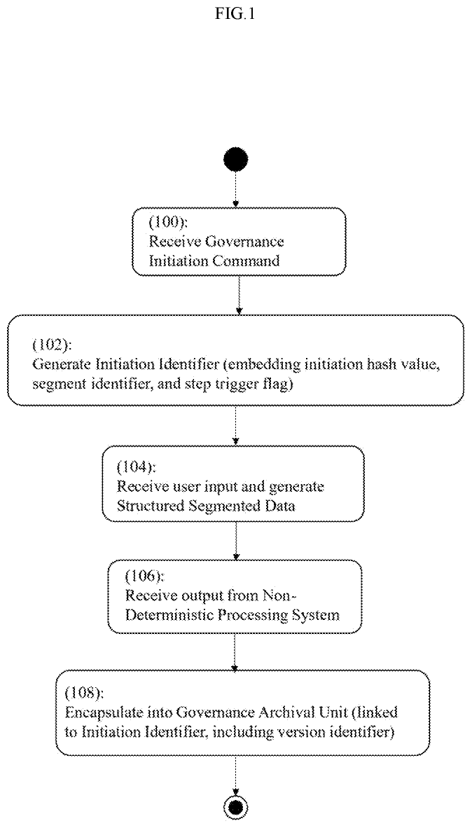

To make the technical content, system architecture, and operational flow of the present disclosure clearer, preferred embodiments are described in conjunction with the accompanying drawings. The system as a whole can be deployed in a middleware environment peripheral to a Non-Deterministic Processing System to maintain technological neutrality and non-intrusive characteristics; in this embodiment, it is presented as a middleware. The system can initialize a governance session via a Governance Initiation Command and generate a Unified Trace Identifier based on the aforementioned Initiation Identifier, thereby establishing a consistent cross-step link throughout the entire governance session. During the archiving flow, the system sequentially executes procedures including Input Structuring Processing, Governance Archival Unit generation, Cryptographic Linking generation, and Behavioral Outcome classification, as shown in FIG. 1 to FIG. 8. Each Governance Archival Unit contains verifiable Structured Segmented Data, NDP Output Data, and Governance Metadata, and is cryptographically bound to the Unified Trace Identifier. This endows the entire archiving session with immutability, traceability, and replayability to support subsequent governance verification and Contextual Replay Reconstruction.

During the governance initiation stage, the system receives a Governance Initiation Command through initiation logic and accordingly determines whether to enter the initialization procedure of the governance session. When the initiation condition is met, the initiation logic generates an Initiation Identifier. This Initiation Identifier serves as the starting tracking baseline of the governance session, enabling the governance flow to possess a verifiable initial state from the moment of initiation. The operational flow of this initiation procedure is shown in (100) and (102) of FIG. 1, where (100) illustrates the reception of the Governance Initiation Command, and (102) illustrates the generation of the Initiation Identifier and the establishment of the initiation state.

To facilitate the understanding of the operation of the initiation logic in FIG. 1, it can be described in pseudocode format as follows:

```
# FIG. 1 - BootTriggerLogic
def BootTriggerLogic( ):
  signal = ReceiveBootPrompt( )
  if ValidateBootSignal(signal):
    startup_id = GenerateStartupID( )
    governance_state = {
      “startup_id”: startup_id,
      “session_state”: “initialized”,
      “timestamp_utc”: NowUTC( )
    }
    return governance_state
  return None
```

### Experimental Support:

Test C01 (Boot ID Generation Test) confirms that upon receiving the Governance Initiation Command, the system can correctly generate a unique Initiation Identifier (startup_id) and successfully establish a traceable initial state for the governance session. Test C02(StructuredInputNormalizationTest) shows that after initiation is complete, the Input Data can correctly enter the Input Structuring Processing flow to form canonical_input, serialized_input, and input_index, supporting the consistent context of subsequent Governance Archival Units. Tests C03 (ArchivalUnitConstructionTest) and C04 (SnapshotHashIntegrityTest) further verify that the Governance Archival Unit AU1 can be correctly encapsulated under the starting tracking baseline established at the initiation stage, and the corresponding snapshot_hash is calculated to maintain the immutability of the archived content. Tests C05 to C05c (MultistepInferenceArchivalTests) confirm that the system can continuously archive a Multi-Step Inference Sequence from AU1 to AU4 based on the Initiation Identifier and the Unified Trace Identifier, maintaining correct Governance Metadata and Sequential Linking Information at each step, and preserving archival consistency. Test C09 (SessionReplayTest) confirms that the system can utilize the established startup_id, boot_hash, and session_state to reconstruct the complete governance session. The replayed content is consistent with the original inference sequence, establishing the critical role of the governance baseline established at the initiation stage for overall verifiability and Contextual Replay Reconstruction.
Based on the experimental results of C01 to C09, the initiation logic of the present disclosure can instantaneously initiate a governance session at the interaction layer, generate a traceable Initiation Identifier, and establish an immutable initial governance state, fully supporting the operational requirements of subsequent Input Structuring Processing, the archiving of a Multi-Step Inference Sequence, and complete Contextual Replay Reconstruction procedures.

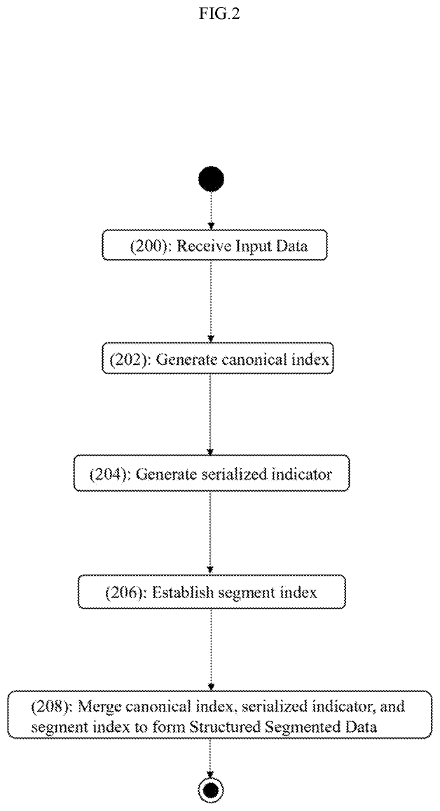

During the input processing stage, based on the starting tracking baseline established by the aforementioned Initiation Identifier, the system receives user input data, application input data, or external event data, and executes canonicalization, serialization, and index generation of the data via the Input Structuring Processing logic. This transforms the Input Data into Structured Segmented Data. This structured format possesses consistent identification capabilities, enabling subsequent governance steps to perform comparison, linking, and encapsulation according to a fixed format. Procedures (200) to (208) of FIG. 2 illustrate the flow of obtaining Input Data, canonicalization processing, serialized indicator generation, and index generation, which corresponds to the Input Structuring Processing requirements set forth in claim 1(b).

To facilitate the understanding of the structured input logic, the functional flow of FIG. 2 is described in pseudocode format as follows:

```
# FIG. 2 - StructuredInputLogic
def StructuredInputLogic(raw_input, startup_id):
  canonical_input = Canonicalize(raw_input)
  serialized_input = Serialize(canonical_input)
  input_index = Hash(serialized_input)
  structured_unit = {
    “startup_id”: startup_id,
    “canonical_input”: canonical_input,
    “serialized_input”: serialized_input,
    “input_index”: input_index,
    “timestamp_utc”: NowUTC( )
  }
  return structured_unit
```

### Experimental Support:

Test C02 (StructuredInputNormalizationTest) confirms that after receiving raw input, the system can correctly execute the three-stage structuring process of canonical_input, serialized_input, and input_index. With governance_state already initialized, it establishes data links according to the Initiation Identifier (startup_id), endowing the Input Data with consistent comparison capabilities and fixed-format identification.
Test C03 (ArchivalUnitConstructionTest) further confirms that the Structured Segmented Data generated by StructuredInputLogic can be correctly encapsulated into the Governance Archival Unit AU1. Its fields (canonical_input, serialized_input, input_index, timestamp_utc) are all successfully written into the Governance Archival Unit Data Structure and can support the subsequent Cryptographic Linking logic.

Test C04 (SnapshotHashIntegrityTest) confirms that AU1 derived from the structured input can have its snapshot_hash correctly calculated, forming an untamperable archival link via a hash function, thereby maintaining consistency among the Structured Data, the Initiation Identifier, and the archival hash value throughout the Multi-Step Inference Sequence.

The experimental results of C02 to C04 collectively confirm that the StructuredInputLogic illustrated in FIG. 2 can complete reproducible, verifiable, and linkable Input Structuring Processing procedures in an actual execution environment, endowing the generation and hash linking of subsequent Governance Archival Units with cryptographic consistency and governance auditing capabilities.

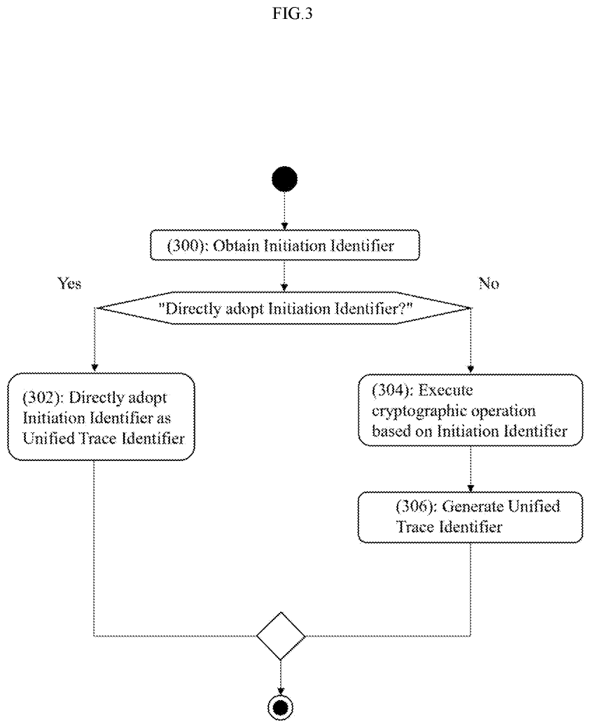

During the Unified Trace Identifier generation stage, the system calculates a consistent Unified Trace Identifier via Unified Trace Identifier generation logic based on the aforementioned Initiation Identifier and the starting time information of the governance session. This serves as the linking baseline for all Input Data, NDP Output Data, and Governance Archival Units during the subsequent governance period. The generation process is shown in FIG. 3, and the execution flow of this logic can be further illustrated by the following pseudocode example.

To facilitate the understanding of the Unified Trace Identifier generation logic, the functional flow of FIG. 3 is described in pseudocode format as follows:

```
# FIG. 3 - UnifiedTrackingIDGenerationLogic
def generate_unified_tracking_id(startup_id, timestamp_utc):
  composite_value = startup_id + “:” + timestamp_utc
  unified_tracking_id = sha256_hash(composite_value)
  return unified_tracking_id
```

### Experimental Support:

The Unified Trace Identifier generation logic (UnifiedTrackingIDGenerationLogic) of the present disclosure has been verified by multiple sets of experiments for its reproducibility, consistency, and Cryptographic Linking capabilities. First, C01 (StartupIDGenerationTest) confirms that the system can stably generate a unique Initiation Identifier after receiving the Governance Initiation Command, serving as the initial baseline for the Unified Trace Identifier. Second, C02 (StructuredInputNormalizationTest) further confirms that all subsequent Structured Data can correctly carry the startup_id, forming a consistent link between the Unified Trace Identifier and the Input Data. During the Governance Archival Unit establishment process, C03 (ArchivalUnitConstructionTest) and C04 (SnapshotHashIntegrityTest) respectively verify that the Unified Trace Identifier can be correctly embedded into the Governance Metadata of the Governance Archival Unit and maintain immutability within the hash link.
Simultaneously, C05, C05b, and C05c (Multi-StepInferenceArchivalTests) collectively confirm that in a scenario of archiving a Multi-Step Inference Sequence, all Governance Archival Units use the same Unified Trace Identifier as the cross-step linking baseline, forming a verifiable inference sequence. Finally, C09 (SessionReplayReconstructionTest) confirms that the system can reconstruct the complete governance session context from any archiving step using the Unified Trace Identifier, establishing its functional effectiveness during verification, auditing, and replay processes.

In summary, the Unified Trace Identifier generation logic of the present disclosure possesses verifiability, reproducibility, and cryptographic linking consistency, supporting the reliable execution of the overall governance archiving flow in real-world operational environments.

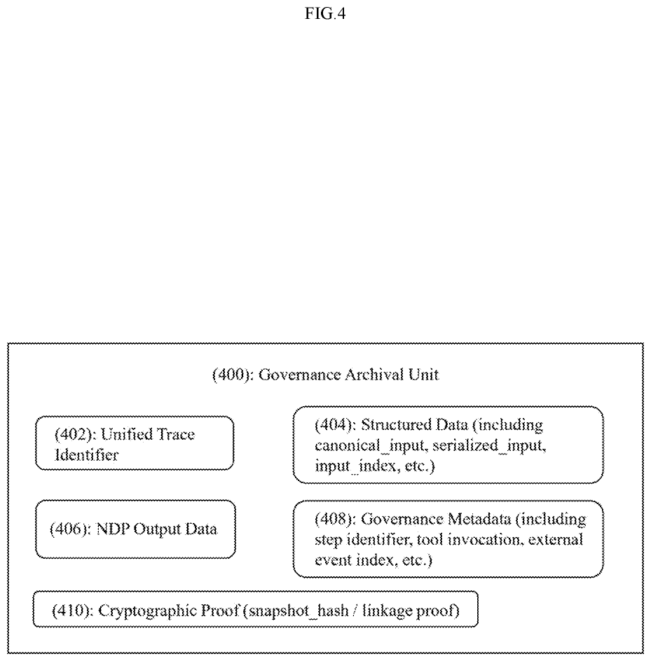

During the data harmonization stage, based on the structuring processing requirements set forth in claim 1(b), the system standardizes, formats, and serializes the Structured Segmented Data produced by the aforementioned Input Structuring Processing logic through input data harmonization processing logic. This ensures that the data maintains a consistent identification format across different governance steps. This harmonization process ensures that subsequent inference steps, when faced with diverse input contents, can still guarantee the comparability and linkability of the Governance Archival Units. The operational flow, as shown in FIG. 4, includes three stages: standardization processing, serialization processing, and hash index generation. Through the harmonized data segmentation results, it provides the unified data representation required for subsequent comparison, encapsulation, and verification during the governance period.

To facilitate the understanding of the input data harmonization processing logic, the functional flow shown in FIG. 4 is illustrated in pseudocode format as follows:

# FIG. 4 - InputNormalizationLogic

| | |
|---|---|
| def | normalize_input(structured_unit): |
| | canonical_input = structured_unit[“canonical_input”] |
| | serialized_input = Serialize(canonical_input) |
| | normalized_index = Hash(serialized_input) |
| | normalized_unit = { |
| | “canonical_input”: canonical_input, |
| | “serialized_input”: serialized_input, |
| | “input_index”: normalized_index, |
| | “timestamp_utc”: NowUTC( ) |
| | } |
| | return normalized_unit |

### Experimental Support:

Test C02 (StructuredInputNormalizationTest) confirms that with the Initiation Identifier already established, the Input Data can correctly generate canonical_input, serialized_input, and input_index via standardization and serialization procedures, ensuring the data possesses consistent comparison capabilities during the governance period. Test C03 (ArchivalUnitConstructionTest) further verifies that the Structured Data fields obtained from the harmonization process can be correctly encapsulated into the Governance Archival Unit AU1, allowing the harmonized Structured Data and Governance Metadata to jointly form the archival structure. Test C04 (SnapshotHashIntegrityTest) confirms that the harmonized canonical_input and serialized_input can be correctly included in the archival hash calculation, maintaining the untamperability of the Governance Archival Unit across the Multi-Step Inference Sequence. In the scenario of a Multi-Step Inference Sequence, C05, C05b, and C05c (Multi-Step Inference Archival Tests) collectively confirm that the harmonized Structured Data maintains hash linking and data identification consistency between AU1 and AU4, ensuring that subsequent archiving steps can still perform verification and linking based on this harmonized result. In summary, the input data harmonization processing logic possesses reproducibility, verifiability, and cross-step consistency in the actual governance flow, fully supporting the data harmonization requirements set forth in claim 1(b).

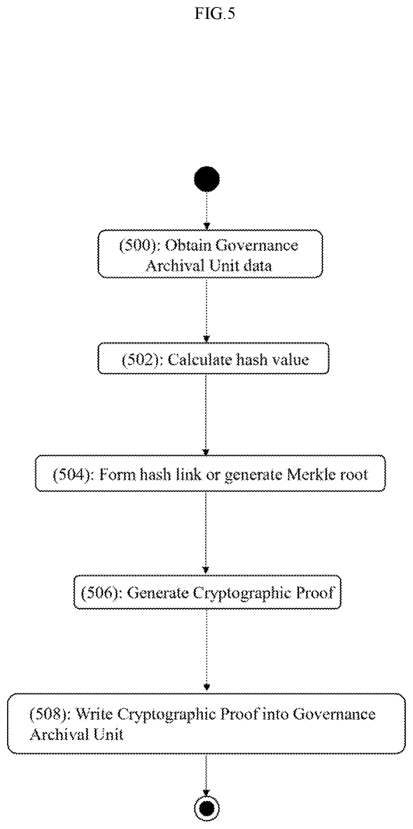

During the inference output generation stage, based on the processing requirements set forth in claim 1(c), the system submits the aforementioned harmonized Structured Data to the Non-Deterministic Processing System via inference output generation logic, enabling it to generate corresponding NDP Output Data according to various internal mechanisms. Because the Non-Deterministic Processing System may produce variable results during each inference process, the inference output generation logic must structurally combine this output content with the harmonized Structured Data into a Governance Archival Unit to serve as the core data source for subsequent verification, comparison, and governance behaviors. The flow, as shown in FIG. 5, includes steps such as inference triggering, inference response acquisition, Governance Metadata annotation, and Governance Archival Unit structure generation.

To facilitate the understanding of the inference output generation logic, the following pseudocode illustrates the functional flow shown in FIG. 5:

# FIG. 5 - InferenceOutputLogic (revised)

| | |
|---|---|
| def | generate_inference_unit(normalized_unit): |
| | output_data = |

Inference(normalized_unit[“canonical_input”])

```
governance_metadata = {
  “timestamp_utc”: NowUTC( ),
  “model_used”: “models/gemini-2.5-flash”
}
archival_unit = {
  “structured_data”: normalized_unit,
  “output_data”: output_data,
  “governance_metadata”: governance_metadata
}
return archival_unit
```

### Experimental Support:

Test C03 (ArchivalUnitConstructionTest) confirms that the inference output generation logic can correctly encapsulate the harmonized Structured Data and the output_data generated by the inference engine into the Governance Archival Unit AU1, and add Governance Metadata (governance_metadata) into the same unit, forming an archival data structure possessing a verifiable context and source attributes. Test C04 (SnapshotHashIntegrityTest) further verifies that the aforementioned Governance Archival Unit can successfully calculate a snapshot_hash and maintain immutability within the hash link, ensuring that the overall archival structure of the NDP Output Data and the Governance Metadata has not been tampered with.

In the scenario of a Multi-Step Inference Sequence, C05, C05b, and C05c (Multi-Step Inference Archival Tests) collectively confirm that the inference output generation logic can continuously archive multiple inference results from AU1 to AU4. All Governance Archival Units retain the link between the harmonized Structured Data and the latest model output, endowing the inference path with cross-step completeness and traceability. Test C06 (InferenceBehaviorClassificationTest) shows that the Governance Metadata can correctly record inference latency, token usage, and other attributes reflecting inference behavior, enabling the Governance Archival Unit to support subsequent behavioral classification and inference quality evaluation.

Test C07 (InferenceErrorArchivalTest) confirms that upon inference timeout or model anomaly, the inference output generation logic can correctly form an error Governance Archival Unit AU_error, and record the error type, error message, and time information, endowing the abnormal state with traceability. Test C09 (SessionReplayTest) confirms that the multi-step inference archival data can correctly reconstruct the complete inference sequence utilizing the Unified Trace Identifier and the Governance Metadata, endowing the inference context with replayable and verifiable capabilities.

In summary, based on the harmonized Structured Data in actual governance scenarios, the inference output generation logic can produce Governance Archival Units possessing traceability, immutability, and a complete context. This fully supports the archiving requirements and governance necessities set forth in claim 1(c), endowing the overall inference flow with verifiable, comparable, and replayable governance capabilities.

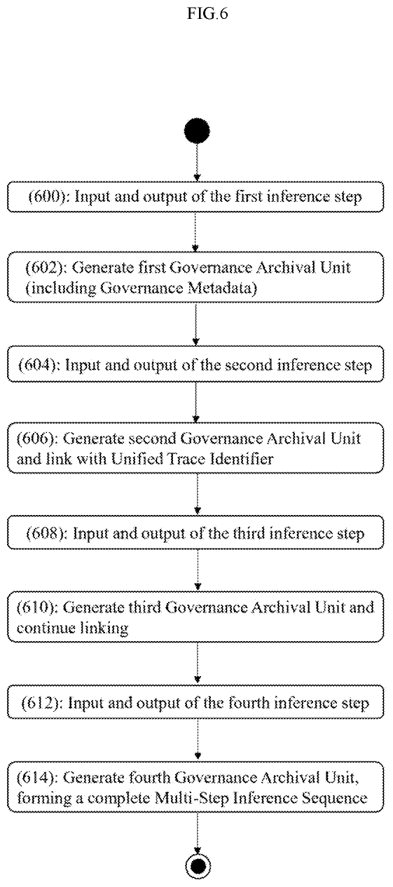

During the archive hash generation stage, the system, via archive hash generation logic, combines the content of the aforementioned Governance Archival Unit and the corresponding governance tracking information into an input for a cryptographic hash calculation to generate a corresponding archive hash value. When necessary, it links this with the hash result of the previous archiving step to form an untamperable archive chain. By performing chained calculations on the content digest of each Governance Archival Unit and the previous archival result, the present disclosure can establish an archival sequence with context dependency during the governance period, enabling the detection of any alteration to the content of any Governance Archival Unit through recalculation and comparison of the hash results. The archive hash generation and linking flow can be illustrated by the steps shown in FIG. 6, which include the main stages of archival data combination, hash calculation, link result establishment, and archival result output.

The following pseudocode illustrates the archive hash generation logic shown in FIG. 6:

# FIG. 6 - HashSealingLogic (revised)

| | |
|---|---|
| def | seal_archival_unit(archival_unit, unified_tracking_id, |

previous_hash=None):

```
payload = Serialize({
  “unified_tracking_id”: unified_tracking_id,
  “governance_archival_unit”: archival_unit,
  “previous_hash”: previous_hash
})
current_hash = sha256_hash(payload)
sealed_unit = {
  “unified_tracking_id”: unified_tracking_id,
  “governance_archival_unit”: archival_unit,
  “current_hash”: current_hash,
  “previous_hash”: previous_hash,
  “timestamp_utc”: NowUTC( )
}
return sealed_unit
```

### Experimental Support:

Test C03 (ArchivalUnitConstructionTest) confirms that the archive hash generation logic can correctly combine the Structured Data, NDP Output Data, and Governance Metadata within the Governance Archival Unit into a serializable payload, serving as the input source for subsequent cryptographic hash calculations. Test C04 (SnapshotHashIntegrityTest) further verifies that after a sha256 calculation, the payload can generate a stable and unique snapshot_hash, and can maintain immutability within the hash linking structure. In the scenario of a Multi-Step Inference Sequence, C05, C05b, and C05c (Multi-Step Inference Archival Tests) collectively confirm that the archive hash generation logic can continuously link previous_hash and current_hash from AU1 to AU4, causing all Governance Archival Units to form an archival sequence with context dependency; any content change in any step will invalidate the subsequent hash links entirely, ensuring the completeness of the archive chain.
Test C07 (InferenceErrorArchivalTest) also confirms that an AU_error generated under abnormal inference conditions can be correctly included in the hash generation flow to form a verifiable error archival link, ensuring that the overall governance chain is not interrupted.
Test C09 (SessionReplayTest) verifies that after the establishment of a complete archival sequence, the Unified Trace Identifier and multi-step hash links can be utilized to reversely reconstruct the inference sequence, enabling the correct replay and verification of the content, step sequence, and inference context of the archive chain.
In summary, the archive hash generation logic of the present disclosure can form an immutable archive chain with context dependency through the Unified Trace Identifier, the content of the Governance Archival Units, and chained hash calculations. This ensures that the overall governance record possesses completeness, verifiability, and traceability, fully supporting the archival linking and governance verification mechanisms set forth in claim 1.

During the Unified Trace Identifier derivation stage, in accordance with the technical features set forth in claim 2, the system performs a derivation process on the aforementioned Initiation Identifier via Unified Trace Identifier derivation logic, endowing it with higher scalability and cross-step linking capability during the governance session. This derivation logic can generate the Unified Trace Identifier using a direct mode or a derivation mode at different steps according to governance requirements, enabling subsequent Governance Archival Units, inference steps, or governance events to undergo consistent linking utilizing the same baseline or its derived baseline. Procedures (300) to (304) of FIG. 3 illustrate the generation and linking flow of the Unified Trace Identifier under the direct mode and the derivation mode, utilizing the derived Unified Trace Identifier as the correlation basis for subsequent archiving and verification steps.

The following pseudocode example describes the operation of the Unified Trace Identifier derivation logic shown in FIG. 3:

# FIG. 3 - UnifiedTrackingIDDerivationLogic (revised)

| | |
|---|---|
| def | DeriveUnifiedTrackingID(startup_id, timestamp_utc=None, |

mode=“direct”):

```
if mode == “direct”:
  return startup_id
else:
  composite = startup_id + “:” + timestamp_utc
  derived_id = sha256_hash(composite)
  return derived_id
```

### Experimental Support:

Test C01 (Boot ID Generation Test) confirms that after the Initiation Identifier is successfully established, the system can directly utilize the Initiation Identifier as the Unified Trace Identifier during the initialization stage. In the subsequent scenario of a Multi-Step Inference Sequence, C05, C05b, and C05c (Multi-Step Inference Archival Tests) further confirm that the Unified Trace Identifier under the derivation mode can undergo hash derivation by incorporating governance context information such as an inference timestamp, and maintain cross-step linking consistency during the period from AU1 to AU4. This enables the Governance Archival Units to execute linking, verification, and sequence reconstruction utilizing the same baseline or its derived baseline.
Test C09 (SessionReplayTest) also shows that after the end of the governance session, the system can correctly reconstruct the archival sequence of a Multi-Step Inference Sequence utilizing the Unified Trace Identifier (direct mode or derivation mode), and verify that no errors or chain-breaking situations have occurred regarding the hash chain consistency, inference context, and archival sequence.
In summary, the experimental results of C01, C05 to C05c, and C09 fully prove that the Unified Trace Identifier derivation logic possesses consistency, reproducibility, and cross-step linking capability, supporting the identifier derivation mode set forth in claim 2 and strengthening the tracking integration capability of the governance record generation flow set forth in claim 1.

During the Input Structuring Processing stage, in accordance with the limitation of claim 3, the system establishes at least one canonical index, a serialized indicator, or Governance Metadata for the aforementioned Input Data via Input Structuring Processing logic, enabling the Input Data to maintain consistent comparison capabilities during subsequent governance verification or behavioral replay. The processing flow, as shown in procedures (200) to (208) of FIG. 2, includes steps such as obtaining Input Data, generating a canonical index, establishing a serialized indicator, forming a segment index (in some embodiments), and integrating structured results, ultimately forming Structured Segmented Data that meets governance requirements. This enables the Input Data to possess comparability and consistency without altering its semantic content. To facilitate the understanding of the logical operation shown in FIG. 2, the following pseudocode example describes the execution manner of the Input Structuring Processing logic:

# FIG. 2 - StructuredInputLogic

| | |
|---|---|
| def | StructuredInputLogic(raw_input, startup_id): |
| | canonical_input = Canonicalize(raw_input) |
| | serialized_input = Serialize(canonical_input) |
| | input_index = Hash(serialized_input) |
| | structured_unit = { |
| | “startup_id”: startup_id, |
| | “canonical_input”: canonical_input, |
| | “serialized_input”: serialized_input, |
| | “input_index”: input_index, |
| | “timestamp_utc”: NowUTC( ) |
| | } |
| | return structured_unit |

### Experimental Support:

Test C02 (StructuredInputNormalizationTest) confirms that with the Initiation Identifier already established, Input Data from any source can correctly form canonical_input, serialized_input, and input_index via Canonicalize, Serialize, and Hash indexing procedures, perfectly corresponding to the structuring requirements of the canonical index, serialized indicator, and Governance Metadata set forth in claim 3. Test C03 (ArchivalUnitConstructionTest) further verifies that the aforementioned Structured Data can be correctly encapsulated into AU1, enabling the Input Data structure and Governance Metadata to jointly form a complete Governance Archival Unit. Test C04 (SnapshotHashIntegrityTest) confirms that canonical_input, serialized_input, and input_index are all correctly included in the archival hash calculation, maintaining the untamperability of the Governance Archival Unit across the Multi-Step Inference Sequence. In the scenario of a Multi-Step Inference Sequence, C05, C05b, and C05c (Multi-Step Inference Archival Tests) further demonstrate that the entire sequence from AU1 to AU4 maintains consistent Input Data identification and hash linking, endowing the Structured Data with cross-step comparison capabilities and contextual consistency during the governance period. In summary, the Input Structuring Processing logic possesses reproducibility, verifiability, and semantic invariance within the governance flow, fully supporting the technical features set forth in claim 3.

During the encapsulation stage of the data harmonization results, based on the Structured Input Data set forth in claim 3, the system establishes the Governance Archival Unit Data Structure shown in FIG. 4. FIG. 4 is a schematic diagram of a static data structure, rather than a flowchart, illustrating five core fields of the Governance Archival Unit (400), including a Unified Trace Identifier (402), Structured Input Data (404), NDP Output Data (406), Governance Metadata (408), and a Cryptographic Proof (410). Therein, the Structured Input Data field (404) further includes canonical_input, serialized_input, and input_index, enabling the input content to maintain consistent comparison capabilities across different governance steps and inference scenarios. This data field structure enables the system to directly reference the aforementioned harmonized fields during subsequent archiving, verification, and Contextual Replay Reconstruction, without the need to re-execute the Input Structuring Processing, while ensuring that the input semantics remain unchanged and maintaining cross-step consistent identifiability.

### Experimental Support:

Test C02 (StructuredInputNormalizationTest) confirms that canonical_input, serialized_input, and input_index are correctly generated and possess consistent comparison capabilities; Test C03 (ArchivalUnitConstructionTest) confirms that each field is correctly encapsulated into AU1; Test C04 (SnapshotHashIntegrityTest) confirms that the aforementioned fields are all included in the hash calculation, forming an immutable archival structure; Tests C05, C05b, and C05c (Multi-Step Inference Archival Tests) confirm that the field remains stable throughout the entire Multi-Step Inference Sequence from AU1 to AU4, and can serve as the baseline for subsequent comparison and Contextual Replay Reconstruction.
In summary, the data structure shown in FIG. 4 fully supports the technical requirements for the Structured Input Data, harmonized representation, and data field configuration set forth in claim 3 and claim 10.

During the governance archiving stage, through Cryptographic Linking logic, the system encodes and hashes the Structured Input Data, NDP Output Data, and Governance Metadata contained in the Governance Archival Unit to obtain a Cryptographic Proof (proof of immutability) representing the Governance Archival Unit. According to the implementation aspects of claim 4, this calculation can utilize a hash chain method to link the current hash value with the hash value of the previous Governance Archival Unit, or utilize a Merkle tree structure to calculate a Merkle root to ensure the completeness of batch data. Furthermore, the system can also apply a digital signature to the linked result or write it to an immutable storage medium. These linking methods ensure that if the content of any Governance Archival Unit is altered, its corresponding hash verification or signature verification will fail, thereby enabling immediate detection during subsequent verification. Procedures (500) to (506) of FIG. 5 illustrate the data combination, hash or Merkle root generation, link establishment, and proof output flow of the Cryptographic Linking, fully corresponding to the Cryptographic Linking methods set forth in claim 4.

The following pseudocode example illustrates the operation of the Cryptographic Linking logic shown in FIG. 5:

# FIG. 5 - CryptographicLinkingLogic (revised)

| | |
|---|---|
| def | CryptographicLinkingLogic(sealed_unit, |
| | previous_proof, |
| method=“chain”): | |
| | payload = Serialize({ |
| | “unit”: sealed_unit, |
| | “previous”: previous_proof |
| | }) |
| | if method == “merkle”: |
| | proof = CalculateMerkleRoot([payload, |
| | previous_proof]) |
| | else: |
| | proof = sha256_hash(payload) |
| | linked_record = { |
| | “unit”: sealed_unit, |
| | “cryptographic_proof”: proof, |
| | “previous”: previous_proof, |
| | “timestamp_utc”: NowUTC( ) |
| | } |
| | return linked_record |

### Experimental Support:

Test C03 confirms that after the Governance Archival Unit AU1 contains canonical_input, serialized_input, NDP Output Data, and Governance Metadata, it can successfully serve as the input source for the Cryptographic Linking logic. Test C04 verifies that the Cryptographic Linking logic can perform serialization and hash calculations on the content of the Governance Archival Unit, generating a Cryptographic Proof possessing immutability. In the scenario of a Multi-Step Inference Sequence, C05, C05b, and C05c demonstrate that the previous_hash and current_hash are correctly linked between AU1 and AU4, enabling the Governance Archival Units to form an archival sequence with context dependency. Test C07 confirms that the error Governance Archival Unit AU_error can also be included in the hash linking flow. Test C09 confirms that the Cryptographic Proof generated by the Cryptographic Linking logic can be completely verified during the replay process. In summary of the results from C03 to C09, the Cryptographic Linking logic of the present disclosure possesses reproducibility, untamperability, and cross-step dependency, fully supporting the Cryptographic Linking methods set forth in claim 4.

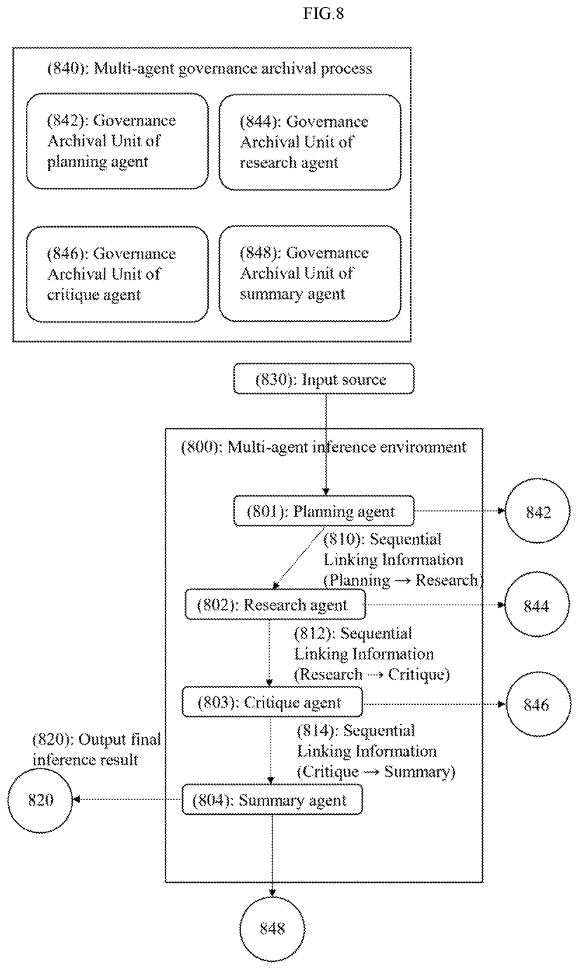

During the multi-step governance recording stage, based on the Unified Trace Identifier set forth in claim 1, the system progressively encapsulates the Input Data, NDP Output Data, Governance Metadata, and Cryptographic Linking results of each inference or decision step within the lifecycle of the governance session. This enables the Governance Archival Unit of each step to possess verifiability, and utilizes the hash value of the previous archiving step as a linking baseline to form a governance linking sequence possessing causal sequence and untamperability. By generating a corresponding Governance Archival Unit immediately after the completion of each inference step, the entire inference path can be completely reconstructed during governance verification or Contextual Replay Reconstruction. FIG. 8 illustrates this multi-step governance linking flow, including main procedures such as step serialization, cross-step linking, and Contextual Replay Reconstruction.

The following pseudocode example demonstrates the generation logic of the multi-step governance sequence shown in FIG. 8:

# FIG. 8 - MultiStepInferenceLogic

| | |
|---|---|
| def | MultiStepInferenceLogic(normalized_unit, |

unified_tracking_id, previous_hash=None):

model_output =

Inference(normalized_unit[“canonical_input”])

```
archival_unit = {
  “input_structured”: normalized_unit,
  “model_output”: model_output,
  “governance_metadata”: {
    “timestamp_utc”: NowUTC( )
  }
}
payload = Serialize({
  “unified_tracking_id”: unified_tracking_id,
  “archival_unit”: archival_unit,
  “previous_hash”: previous_hash
})
current_hash = sha256_hash(payload)
sealed_unit = {
  “unified_tracking_id”: unified_tracking_id,
  “archival_unit”: archival_unit,
  “current_hash”: current_hash,
  “previous_hash”: previous_hash,
  “timestamp_utc”: NowUTC( )
}
return sealed_unit
```

### Experimental Support:

Test C03 (ArchivalUnitConstructionTest) confirms that each inference step can form a Governance Archival Unit AU1 possessing canonical_input, model_output, and Governance Metadata, enabling the archival sequence of the Multi-Step Inference Sequence to establish a consistent data structure. Test C04 (SnapshotHashIntegrityTest) verifies that after serialization, the Governance Archival Unit can correctly calculate a snapshot_hash and establish a link with previous_hash, endowing the archive chain with immutability. In the scenario of a Multi-Step Inference Sequence, C05, C05b, and C05c (Multi-Step Inference Archival Tests) demonstrate that the linking sequence is consistent between AU1 and AU4, and current_hash completely corresponds to the previous_hash of the previous archiving step, confirming that the multi-step governance sequence possesses causal continuity and verifiability. Test C09 (SessionReplayTest) further confirms that the system can reconstruct the entire inference sequence utilizing the Unified Trace Identifier and multi-step hash links, enabling the complete recovery of the content and context of each inference step. In summary of the results of C03, C04, C05 to C05c, and C09, the generation logic of the multi-step governance sequence of the present disclosure possesses cross-step linking stability, sequence consistency, and replay verifiability, fully supporting the multi-step governance recording capabilities set forth in claim 5.

During the inference of a Multi-Step Inference Sequence in a governance session, the system, via Governance Metadata annotation logic, records external tool identification information, tool invocation parameters, external sub-process identifications, or inference bases involved in each inference step into the Governance Archival Unit. This enables subsequent verification of the behavioral establishment conditions of each step. The aforementioned Governance Metadata, serving as an extended attribute of the Governance Archival Unit, provides complete contextual information for each inference step, endowing the step with traceability and interpretability during replay, verification, or variance comparison.

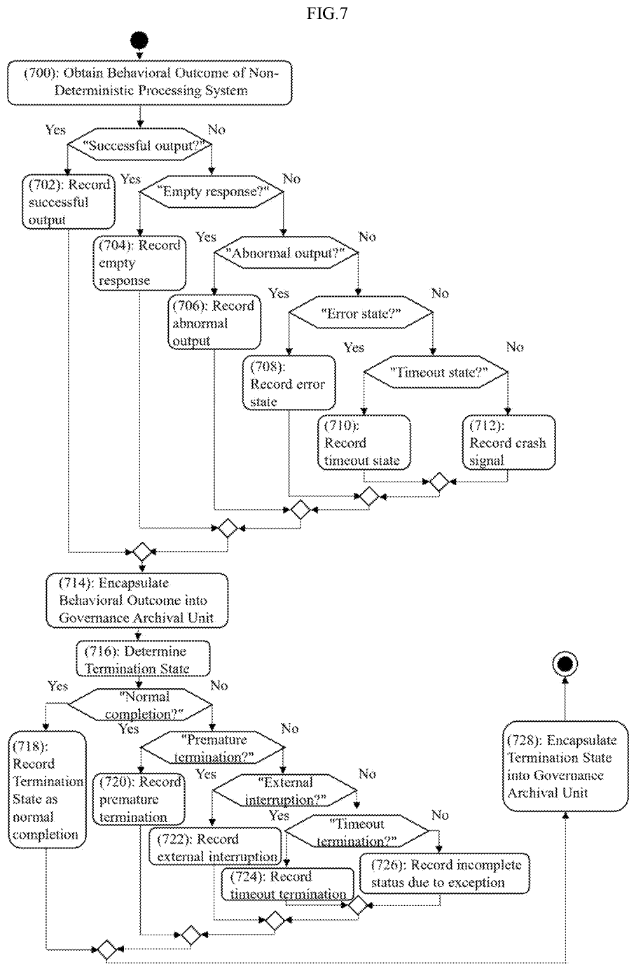

Procedures (700) to (704) of FIG. 7 illustrate the main flow of Governance Metadata annotation, including stages such as tool information extraction, step basis collection, metadata integration, and Governance Archival Unit updating. Through this Governance Metadata annotation procedure, the system can establish a traceable behavioral context at each inference stage, enabling it to be consistently verified in subsequent governance procedures.
The following pseudocode example illustrates the Governance Metadata annotation logic shown in FIG. 7:

# FIG. 7 - GovernanceMetadataLogic

| | |
|---|---|
| def | GovernanceMetadataLogic(archival_unit, tool_info, |

step_reference):

```
metadata_extended = {
  “tool_info”: tool_info,
  “step_reference”: step_reference,
  “timestamp_utc”: NowUTC( )
}
archival_unit[“governance_metadata_extended”] =
```

metadata_extended

return archival_unit

### Experimental Support:

Test C03 (ArchivalUnitConstructionTest) confirms that when a Governance Archival Unit is established, the basic Governance Metadata field (governance_metadata) can be correctly added, which includes an inference timestamp and model identification information. Test C05 (MultistepInferenceTest-AU2) further demonstrates that the Governance Archival Unit of the second step of the Multi-Step Inference Sequence can correctly record the inference basis and context of that step; Tests C05b (AU3) and C05c (AU4) confirm that during the continuous inference process, external tool identification information (tool_info), tool invocation parameters, and external sub-process identifications (step_reference) can all be correctly written into the Governance Metadata field at each step, and the Governance Metadata maintains a harmonized format and verifiable linking between AU1 and AU4. The results of C03 to C05c collectively prove that the Governance Metadata annotation logic can instantaneously establish a complete behavioral context at each inference step, endowing subsequent verification, replay, and variance comparison procedures with stable traceability and auditability, thereby fully supporting the governance requirements for external tools participating in the inference flow set forth in claim 6.

During the end stage of a governance session, via Termination State archiving logic, after determining the final behavioral state of the governance session, the system encapsulates the Termination State together with related Governance Metadata into a Governance Archival Unit. This enables the final state of the governance session in its entire lifecycle to be precisely recorded and verified during subsequent governance verification. The Termination State may include normal completion, premature termination, external interruption, timeout termination, or incomplete status due to exception events. Its classification and archiving flow, as shown in FIG. 7, includes procedures such as obtaining a Behavioral Outcome, determining state classification, marking the final state, and archiving output. By treating the Termination State as independent archival content, the present disclosure can ensure that the ending conditions of the governance session possess traceability and verifiability, enabling a governance verifier to accurately identify the session ending reason and behavioral context during subsequent replay or anomaly analysis.

The following pseudocode illustrates the Termination State archiving logic shown in FIG. 7:

# FIG. 7 - TerminationStateLogic

| | |
|---|---|
| def | TerminationStateLogic(behavior_outcome, |

unified_tracking_id):

termination_state =

DetermineTerminationState(behavior_outcome)

```
termination_unit = {
  “unified_tracking_id”: unified_tracking_id,
  “termination_state”: termination_state,
  “behavior_outcome”: behavior_outcome,
  “timestamp_utc”: NowUTC( )
}
return termination_unit
```

### Experimental Support:

Test C01 (Boot ID Generation Test) and Test C02 (StructuredInputNormalizationTest) confirm that from the initiation of the governance session to the input processing period, both the Initiation Identifier and the Unified Trace Identifier can be correctly established and continuously utilized until the end of the session. Tests C03 (ArchivalUnitConstructionTest) and C04 (SnapshotHashIntegrityTest) show that the Governance Archival Unit can be correctly formed after the completion of the inference step, and generate a corresponding cryptographic hash value, ensuring that each archiving step possesses completeness and verifiability throughout the lifecycle of the session. In the scenario of a Multi-Step Inference Sequence, C05, C05b, and C05c (Multi-Step Inference Archival Tests) confirm that the archival sequence from AU1 to AU4 can all be linked according to the Unified Trace Identifier and previous_hash. This enables the system to accurately identify the final inference step at the end of the session and establish a final state that can be referenced by the session termination logic. Finally, Test C09 (SessionReplayTest) verifies that during the replay process, the session sequence can be completely reconstructed via the Unified Trace Identifier, and the Termination State and Behavioral Outcome can be correctly identified, endowing the archived Termination State with verifiability and traceability during subsequent verification, replay, and anomaly analysis. The aforementioned experiments C01 to C09 collectively confirm that the Termination State archiving logic can instantaneously generate a correct Governance Archival Unit for the Termination State at the end of a governance session, and provide a complete ending context to support the technical requirements set forth in claim 7.

During a governance session, a Non-Deterministic Processing System may generate various types of Behavioral Outcomes due to inference randomness, model states, external tool dispatching, network environments, or other operational factors. To ensure that Governance Archival Units possess complete contextual information during subsequent verification, replay, and anomaly detection, the Behavioral Outcome classification logic of the present disclosure annotates all observable behavioral states during the inference process in a unified format, making them a part of the Governance Archival Unit.

This Behavioral Outcome classification includes at least one of a successful output, empty response, abnormal output, error state, timeout state, or crash signal. Various types of states are encoded in a harmonized manner within the archival records, enabling a third party to identify the inference state and clarify behavioral causes during verification or analysis. The flow of FIG. 8 illustrates the behavioral state determination procedure after obtaining an inference result, including steps such as inference completion signal judgment, content validity checking, exception event capturing, and timeout monitoring. After classification, it is incorporated into the Governance Metadata to support subsequent Contextual Replay Reconstruction and completeness verification.
To facilitate the understanding of the Behavioral Outcome classification logic shown in FIG. 8, the following pseudocode illustrates its operational flow:

# FIG. 8 - BehavioralOutcomeClassificationLogic

| | |
|---|---|
| def | ClassifyBehavioralOutcome (output, error_flag=None, |

timeout_flag=False):

```
if timeout_flag:
  return “TIMEOUT”
if error_flag is not None:
  return “ERROR”
if output is None:
  return “EMPTY”
if IsMalformed(output):
  return “ABNORMAL”
return “SUCCESS”
```

### Experimental Support:

Test C06 (BehaviorSuccessClassificationTest) confirms that the system can correctly generate a Behavioral Outcome classification of the SUCCESS type when an inference is successful, and write the inference content, extended metadata, and the SUCCESS tag into the Governance Archival Unit, enabling the successful inference result to be consistently identified during replay and auditing. Test C07 (BehaviorTimeoutAndErrorTest) further verifies that the system can correctly classify the state as TIMEOUT or ERROR when an inference times out or generates an error signal, and write the corresponding state into the Behavioral Outcome field, endowing abnormal inferences with distinguishability and traceability during subsequent verification.

Furthermore, in the scenario of a Multi-Step Inference Sequence, Tests C05 to C05c (Multi-Step Inference Archival Tests) show that each Governance Archival Unit from AU1 to AU4 retains the Behavioral Outcome field and continuously maintains classification consistency across multiple inferences. This enables the inference path to be precisely reconstructed during replay based on types such as SUCCESS, EMPTY, ERROR, or TIMEOUT. In summary of the aforementioned experiments, the Behavioral Outcome classification logic possesses reproducibility, verifiability, and cross-step consistency in an actual governance flow, fully supporting the technical requirements set forth in claim 8.

The Non-Deterministic Processing System of the present disclosure includes at least one processor and a memory. The processor is configured to execute the governance record generation method set forth in claims 1 to 8, and through a plurality of governance-related logics internal to the system, enables the overall governance flow to operate collaboratively at the hardware layer and the software layer. The system architecture can refer to the overall schematic of FIG. 8, which includes processing procedures required for governance operations, such as initiation logic, Unified Trace Identifier generation logic, structured input logic, input data harmonization processing logic, inference output generation logic, archive hash generation logic, and Governance Archival Unit assembly logic. By executing the aforementioned logics in the processor and storing the corresponding governance data, Governance Archival Units, and Governance Metadata in the memory, the system can form a governance data flow possessing consistent linkability and immutability during the governance period.

To more specifically illustrate the system operation shown in FIG. 8, one of the aforementioned logics (e.g., Governance Archival Unit assembly logic) can be illustrated in pseudocode as follows:

# FIG. 8 - ArchivalUnitAssemblyLogic

| | |
|---|---|
| def | AssembleArchivalUnit(unified_tracking_id, |

normalized_input, model_output, metadata):

```
unit = {
  “unified_tracking_id”: unified_tracking_id,
  “input_structured”: normalized_input,
  “model_output”: model_output,
  “governance_metadata”: metadata
}
return unit
```

### Experimental Support:

Test C01 (Boot ID Generation Test) confirms that the system can correctly generate a startup_id and a Unified Trace Identifier (UTI) during the initiation stage, and establish an initial governance state in the memory, corresponding to the initiation logic and the Unified Trace Identifier generation logic in the system architecture. Test C02 (StructuredInputNormalizationTest) and Test C03 (ArchivalUnitConstructionTest) respectively verify that the processor can execute the structured input logic and the Governance Archival Unit assembly logic, and maintain harmonized data such as canonical_input, serialized_input, and input_index in the memory. Test C04 (SnapshotHashIntegrityTest) confirms that the processor can correctly execute the archive hash generation logic, and write current_hash and previous_hash into the Governance Archival Unit to form an immutable link.
Tests C05 to C05c (Multi-Step Inference Archival Tests) show that the processor can continuously execute a plurality of governance logics, such as inference output generation, archival assembly, and Cryptographic Linking, and successfully maintain a cross-step archival sequence from AU1 to AU4 in the memory. Test C08 (TerminationStateArchival Test) confirms that the system can correctly generate a termination_unit and write the Unified Trace Identifier at the session end stage, forming a final Governance Archival Unit. Test C09 (SessionReplayTest) shows that the system can reconstruct the complete inference sequence via the Unified Trace Identifier, Governance Archival Units, and linking proofs stored in the memory, proving that the system-level architecture can correctly execute all governance logics set forth in claims 1 to 8.
Tests M01, M02, and M03 (Multi-Agent series) further confirm that when the processor runs Multi-Agent Collaborative Inference, concurrent inference, and collaborative inference scenarios, the system can still correctly archive and assemble Governance Archival Units according to the Unified Trace Identifier, ensuring that the governance data possesses consistent linkability and immutability in the memory. The aforementioned experiments collectively prove that the system of the present disclosure can completely execute the governance record generation, archiving, and verification mechanisms set forth in claims 1 to 8 at the hardware layer and the software layer.

A Non-Deterministic Processing System of the present disclosure includes at least one processor and a memory. The processor is configured to execute the governance record generation method set forth in claims 1 to 8, and sequentially execute a plurality of governance processing procedures during the lifecycle of a governance session, including initiation logic, Unified Trace Identifier generation logic, Input Structuring Processing logic, inference output generation logic, Governance Metadata annotation logic, Cryptographic Linking generation logic, and Governance Archival Unit encapsulation logic. The memory is used to store governance data such as the Initiation Identifier, the Unified Trace Identifier, Structured Input Data, NDP Output Data, Governance Metadata, Behavioral Outcome classification, and archive hash, enabling the overall governance flow to maintain continuity, consistency, and immutability at the hardware layer and the software layer.

The system architecture can refer to the schematic of FIG. 8, wherein the processor is responsible for executing various logic procedures in the governance record generation method, and establishing linking relationships of cross-step governance data in the memory, enabling the present disclosure to form a complete, verifiable, and replayable inference context during the governance period. Because the processor can link a Multi-Step Inference Sequence or decision steps based on the Unified Trace Identifier, it can ensure that the sources, timings, and contexts of all Governance Archival Units can be completely identified during subsequent governance verification, auditing, or Contextual Replay Reconstruction.

During the data structure establishment stage of the Governance Archival Unit, the system generates an archival data structure comprising Sequential Linking Information, Input Data, NDP Output Data, Governance Metadata, and a Cryptographic Proof, based on the operational result of the Non-Deterministic Processing System set forth in claim 9. This data structure is used as a verifiable encapsulation unit of the complete inference context during the lifecycle of the governance session, and provides a consistent and immutable data source during subsequent verification, comparison, and behavioral replay.

As shown in FIG. 4, the data structure of the Governance Archival Unit includes five main fields: (a) a Unified Trace Identifier field, (b) a Structured Input Data field, (c) an NDP Output Data field, (d) a Governance Metadata field, and (e) a Cryptographic Proof field. A cross-step linking baseline is formed among the fields via the Unified Trace Identifier, and a proof of immutability is established by an archive hash calculation flow. The elements (400) to (410) of FIG. 4 illustrate the generation, assembly, and archiving output flow of the data fields.
To facilitate the understanding of the data structure generation flow shown in FIG. 4, the following corresponding pseudocode example is provided:

# FIG. 4 - ArchivalRecordConstructionLogic

| | |
|---|---|
| def | BuildArchivalRecord(unified_tracking_id, input_unit, |

output_unit, metadata, proof):

```
record = {
  “unified_tracking_id”: unified_tracking_id,
  “structured_input”: input_unit,
  “model_output”: output_unit,
  “governance_metadata”: metadata,
  “crypto_proof”: proof
}
return record
```

### Experimental Support:

Test C03 (ArchivalUnitConstructionTest) confirms that the system can successfully construct AU1 according to the five core fields (Unified Trace Identifier, Structured Input Data, NDP Output Data, Governance Metadata, Cryptographic Proof), which is completely consistent with the archival data structure described in this paragraph.
Test C04 (SnapshotHashIntegrityTest) further confirms that the crypto_proof field can be correctly generated by the archive hash generation logic, and the archive hash possesses a consistent and untamperable relationship with the Input Data, NDP Output Data, and Governance Metadata.
Tests C05 to C05c (Multi-Step Inference Archival Tests) show that this five-field data structure can be continuously generated in the scenario of a Multi-Step Inference Sequence from AU1 to AU4, and each step is linked by the Unified Trace Identifier, confirming that the data field structure possesses cross-step consistency, verifiability, and complete inference context preservation capabilities.
Test C09 (SessionReplayTest) verifies that the archival data record comprising these five fields can be used to precisely reconstruct the entire inference context, including Input Data, NDP Output Data, Governance Metadata, and hash links, ensuring that the Governance Archival Unit possesses session-level Contextual Replay Reconstruction capabilities. In summary of the experimental results, the data structure of the Governance Archival Unit possesses reproducibility, immutability, and complete inference context support capabilities in actual operations, fully satisfying the technical requirements of claim 10.

In one embodiment, the non-transitory computer-readable storage medium set forth in claim 11 stores a plurality of instructions executable by a processor. When the processor loads and executes the instructions, it can progressively complete governance procedures such as governance initiation, Input Structuring Processing, Unified Trace Identifier generation, inference data encapsulation, and Cryptographic Linking archiving, according to the governance record generation method set forth in any one of claims 1 to 8.

Therein, the instructions stored in the storage medium can cause the processor to sequentially execute the governance steps shown in FIG. 1 to FIG. 6. For example, the initiation logic shown in FIG. 1 can be automatically executed by the processor after loading the instructions to receive the Governance Initiation Command and establish the Initiation Identifier. The Input Structuring Processing shown in FIG. 2 can be executed by the processor to parse and segment the raw input content. The Unified Trace Identifier generation logic shown in FIG. 3 can generate a consistent Unified Trace Identifier when the processor executes the corresponding instructions. The data harmonization processing and inference output generation logic shown in FIG. 4 and FIG. 5 can also be automatically executed via the instructions in the storage medium to obtain a Governance Archival Unit possessing a governance context. The archive hash generation logic shown in FIG. 6 can cause the processor to calculate an archive hash value and establish a linked archival structure, completing the governance archiving flow.
To facilitate the understanding of the instruction content that can be stored in the storage medium set forth in claim 11, the following pseudocode example illustrates how the storage medium, when executed on the processor, sequentially triggers governance procedures such as the initiation flow, input data processing, inference encapsulation, and archive hash generation:

# StorageMediumExecutionLogic - pseudocode example

| | |
|---|---|
| def | ExecuteGovernanceRoutine( ): |
| | ctx = BootTriggerLogic( ) |
| | structured = StructuredInputLogic(GetRawInput( ), |

ctx[“startup_id”])

tracking_id =

UnifiedTrackingIDGeneration(structured[“timestamp_utc”],
ctx[“startup_id”])

normalized = InputNormalizationLogic(structured)
inference_unit = InferenceOutputLogic(normalized)
sealed_unit = HashSealingLogic(inference_unit,

tracking_id)

return sealed_unit

### Experimental Support:

Test C01 (Boot ID Generation Test) and Test C02 (StructuredInputNormalizationTest) confirm that the instructions stored on the non-transitory computer-readable medium can be progressively executed by the processor for the initiation flow and Input Structuring Processing, successfully establishing core governance data structures such as startup_id, the Unified Trace Identifier, and canonical_input/serialized_input/input_index.
Test C03 (ArchivalUnitConstructionTest) and Test C04 (SnapshotHashIntegrityTest) further verify that the processor can generate a Governance Archival Unit, calculate a snapshot_hash, and write the hash into the archival data structure according to the program instructions in the medium, forming an immutable archive chain.
Tests C05 to C05c (Multi-Step Inference Archival Tests) show that the instruction sequence stored in the medium can drive the processor to continuously execute operations such as inference, archiving, and hash linking, successfully generating the archival sequence of the Multi-Step Inference Sequence from AU1 to AU4, and maintaining context linking consistency and data completeness.
Test C08 (TerminationStateArchivalTest) confirms that the Termination State archiving logic instructions in the medium can be executed on the processor and correctly generate a termination_unit, endowing the governance flow with a verifiable termination behavior.
Test C09 (SessionReplayTest) verifies that the replay-related instructions on the medium can enable the processor to execute Contextual Replay Reconstruction of the governance session flow based on the Unified Trace Identifier and the content of the archive chain, showing that the instructions stored in the CRM possess corresponding executability and reproducibility.

In summary of the experimental results from C01 to C09, the governance instructions stored in the non-transitory computer-readable storage medium can be reliably executed on an actual hardware processor, progressively generate an archival data structure, and establish an immutable hash chain, fully supporting the technical requirements set forth in claim 11.

In one embodiment, the Multi-Agent Collaborative Inference environment set forth in claim 12 utilizes a plurality of Agent Models to perform inference in a sequential manner, a concurrent manner, or a combination thereof, utilizing the aforementioned Unified Trace Identifier as a linking baseline during a governance session. It individually records the Agent Role Identifier, input source, and Sequential Linking Information at each inference stage to support subsequent Contextual Replay Reconstruction, sequence verification, and path tracing.

As shown in FIG. 8 (page 8), the Multi-Agent Collaborative Inference environment includes a planning agent, a research agent, a critique agent, and a summary agent. Each Agent Model sequentially or concurrently receives an input source and generates NDP Output Data during the governance session, and the behavioral context of each agent is encapsulated into a corresponding Governance Archival Unit. The Sequential Linking Information in FIG. 8 explicitly illustrates the context dependency among the agents, including the link from the planning agent to the research agent (810), the link from the research agent to the critique agent (812), and the link from the critique agent to the summary agent (814), enabling the overall inference flow to form a traceable collaborative inference structure.

To facilitate the understanding of the Multi-Agent Collaborative Inference set forth in claim 12, its logical flow can be illustrated by the following pseudocode:

# FIG. 8 - MultiAgentInferenceLogic

| | |
|---|---|
| def | MultiAgentInference(input_source, unified_tracking_id): |
| | step1 = PlannerAgent(input_source, unified_tracking_id) |
| | step2 = ResearchAgent(step1[“output”], |

unified_tracking_id)

```
step3 = CriticAgent(step2[“output”], unified_tracking_id)
step4 = SummaryAgent(step3[“output”], unified_tracking_id)
return {
  “planner”: step1,
  “research”: step2,
  “critic”: step3,
  “summary”: step4
}
```

### Experimental Support:

Test M01 (Sequential Multi-Agent Test) confirms that the planning agent, research agent, critique agent, and summary agent can sequentially succeed the output of the previous step, form a multi-agent inference sequence with context dependency under the baseline of the Unified Trace Identifier, and correctly generate a corresponding Governance Archival Unit at each step.
Test M02 (Concurrent Multi-Agent Test) verifies that multiple agents can execute inference in parallel in a concurrent scenario, each agent can still link using the same unified_tracking_id, and maintain the correctness of Governance Metadata and cross-agent context in the Governance Archival Unit.
Test M03 (Cooperative Chain Test) further confirms that in a collaborative mode where “the output of the previous agent serves as the input of the next agent,” multiple agents can correctly generate a cross-agent archival sequence (planner→research→critic→summary), and all Governance Archival Units retain the correct Agent Role Identifier, inference basis, and link hash.
Tests C05 to C05c (Multi-Step Inference Archival Tests) complementarily verify that the multi-agent inference can maintain context linking consistency, hash immutability, and Governance Metadata completeness within the sequence from AU1 to AU4, enabling the multi-agent inference process to be completely reconstructed during subsequent replay.

Test C09 (SessionReplayTest) confirms that based on the multi-agent archival sequence generated by M01 to M03, the entire multi-agent inference path can be correctly reconstructed via the unified_tracking_id, confirming that the role context, dependencies, and inference content can all be verified.

In summary of the experimental results of M01 to M03, C05 to C05c, and C09, it is proven that the Multi-Agent Collaborative Inference possesses sequence reconstructability, role identifiability, and link immutability in an actual governance flow, fully supporting the technical requirements set forth in claim 12.

### End-to-End Governance System Embodiment

In a preferred embodiment, the governance record generation system of the present disclosure can be entirely configured as an end-to-end governance processing architecture, sequentially executing procedures such as initiation, tracking, Input Structuring Processing, the archiving of a Multi-Step Inference Sequence, Cryptographic Linking, and session Termination State output. This ensures that all data of the Non-Deterministic Processing System during the governance period can undergo consistent comparison, source verification, and Contextual Replay Reconstruction. The overall operational flow can correspond to the procedures shown in FIG. 1 to FIG. 8, and can be uniformly presented by the following integrated pseudocode example.

### Overview of End-to-End Flow

First, during the initiation stage, the system receives a Governance Initiation Command and generates an Initiation Identifier via initiation logic to establish the starting tracking baseline of the governance session (FIG. 1). The Initiation Identifier serves as the basis for the subsequent Unified Trace Identifier, enabling the overall governance flow to be verifiable from initiation.

Following this, during the input processing stage, the system receives user Input Data, application data, or external event data, and forms Structured Segmented Data from this data via Input Structuring Processing (FIG. 2). This data is presented in a consistent format during subsequent inference, linking, and archiving.

During the Unified Trace Identifier generation stage, the system generates a Unified Trace Identifier based on the Initiation Identifier and governance time information, making this identifier the core index for the Multi-Step Inference Sequence, data encapsulation, hash linking, and Contextual Replay Reconstruction (FIG. 3).

During the data harmonization stage, the system further ensures that the aforementioned Structured Segmented Data maintains a consistent identifier during the governance period via harmonization processing (FIG. 4).

During the inference output generation stage, the system submits the harmonized data to the Non-Deterministic Processing System, obtains NDP Output Data, and encapsulates it together with Governance Metadata into a Governance Archival Unit.

During the archive hash generation stage, the content of the Governance Archival Unit is serialized and then undergoes a Cryptographic Linking calculation to generate an archive hash value, and is linked with the previous archiving step according to requirements to form an archive chain (FIG. 5). Through this linking method, all Governance Archival Units possess immutability and source verifiability.

In the scenario of a Multi-Step Inference Sequence or Multi-Agent Collaborative Inference, the system incorporates the Agent Role Identifier, input source, Behavioral Outcome, and linking information of each Agent Model into the Governance Archival Unit, making the entire inference path completely traceable (FIG. 6, FIG. 8).

During the final governance stage, the system encapsulates the Termination State of the session, including normal completion, premature termination, timeout termination, or abnormal termination, endowing the entire governance session with a verifiable ending context (FIG. 7).

### End-to-End Integrated Pseudocode

To uniformly present the end-to-end governance flow shown in FIG. 1 to FIG. 8, this embodiment utilizes the following pseudocode to illustrate the complete operation of the overall system during stages such as initiation, tracking, Input Structuring Processing, data harmonization processing, inference archiving, hash linking, and Termination State archiving. This pseudocode integrates logics such as Initiation Identifier generation, Unified Trace Identifier derivation, and Governance Archival Unit construction and link processing, enabling all data of the Non-Deterministic Processing System during the governance period to form a verifiable archival sequence with context dependency. Its operational procedure is shown as follows:

| | |
|---|---|
| def | GovernanceSession(input_stream): |
| | startup_id = GenerateStartupID( ) |
| | trace_id = DeriveUTI(startup_id) |
| | archival_chain = [ ] |
| | previous_hash = None |
| | for raw_input in input_stream: |
| | structured = StructuredInput(raw_input) |
| | normalized = Normalize(structured) |
| | model_output = |

Inference(normalized[“canonical_input”])

```
  metadata = GovernanceMetadata( )
  archival_unit = {
    “trace_id”: trace_id,
    “input”: normalized,
    “output”: model_output,
    “metadata”: metadata
  }
  sealed = HashSeal(archival_unit, trace_id,
```

previous_hash)

```
  archival_chain.append(sealed)
  previous_hash = sealed[“current_hash”]
termination_unit = SealTerminationState(trace_id,
```

previous_hash)

archival_chain.append(termination_unit)
return archival_chain

The above pseudocode shows the end-to-end governance flow of the present disclosure. First, an Initiation Identifier is established via initiation logic, and a unified tracking baseline is obtained via Unified Trace Identifier derivation logic, enabling all Input Data, NDP Output Data, and Governance Archival Units to utilize a consistent key value. Thereafter, at each input batch, Input Structuring Processing, data harmonization processing, and inference output generation are sequentially executed, and the NDP Output Data and Governance Metadata are encapsulated into a Governance Archival Unit. Each Governance Archival Unit then establishes a link with the previous archiving step via hash linking logic, endowing the overall archival sequence with immutability and verifiability. At the end of governance, the Termination State archiving logic generates a final structure of the session, endowing the overall governance session with a verifiable ending context. Through this unified end-to-end archiving flow, the present disclosure can support all technical contents set forth in claims 1 to 12, and endow behaviors of a Multi-Step Inference Sequence with consistency, traceability, and reconstructability.

### Technical Effects

Through the aforementioned end-to-end governance architecture, the system can maintain data consistency, immutability, and traceability across all stages from initiation, data acquisition, inference encapsulation, hash linking, and Multi-Agent Collaborative Inference. At the end of the session, it provides a complete governance termination context, enabling the governance record to be verified, replayed, and subjected to Contextual Replay Reconstruction, thereby supporting all technical contents set forth in claims 1 to 12.

### Industrial Applicability

The present disclosure can be widely applied to the regulatory requirements of artificial intelligence governance, enterprise-level agent systems, cross-agent collaboration platforms, Software-as-a-Service (SaaS) governance frameworks, cloud computing governance platforms, and multi-stage automated inference flows. As large language models are increasingly deployed in decision-making flows, cross-agent inference tasks, and automated control environments, the inference processes, inference paths, and cross-agent collaboration states generated by Non-Deterministic Processing Systems all require verifiability and reconstructability to meet the requirements of security auditing, risk management, cybersecurity auditing, and data source verification. The governance archival linking architecture provided by the present disclosure can correspond to the aforementioned requirements, enabling artificial intelligence systems to maintain completeness, consistency, and source credibility under conditions of high-speed inference, dynamic data exchange, and multi-agent interaction.

Existing artificial intelligence agent systems generally lack a unified tracking baseline and fail to maintain a consistent governance state during multi-stage inference and cross-agent collaboration processes, rendering them unable to provide verifiable records for each governance step. The archiving of inference flows by existing agent frameworks mostly relies on temporary operational contexts, lacks cryptographically strong archival links, and cannot form verifiable context dependencies during non-deterministic inference periods. Cross-agent collaboration flows also lack established mechanisms to generate a Unified Trace Identifier, making it difficult to reconstruct multi-agent inference paths. The governance method disclosed by the present disclosure, through the generation of the Initiation Identifier and the Unified Trace Identifier, can establish a verifiable tracking baseline in any initiation scenario, and through Governance Archival Unit linking, hash sequences, and inference encapsulation mechanisms, forms a governance archival structure with context dependency. This solves the technical gaps of existing technologies in governance tracking, inference reconstruction, and multi-agent harmonization.

The present disclosure has significant promotion benefits in the industry and can be directly applied to various automated intelligent systems that require high credibility and auditability, including fields such as financial risk control, artificial intelligence-assisted decision-making in government administrative flows, enterprise-level automated agent collaboration, model output auditing, automated development flow monitoring, intelligent customer service decision path tracking, data governance flows, and cross-departmental workflow auditing. Through the governance archival model of the present disclosure, artificial intelligence systems can provide complete governance records possessing evidentiary efficacy, reconstructability, and auditable consistency based on the Unified Trace Identifier, archive hash links, and Governance Archival Units. This endows Non-Deterministic Processing Systems with sufficient supervisability, security, and governance transparency in actual industrial operations, thereby improving deployment efficiency and industrial adoption.

### DESCRIPTION OF REFERENCE NUMERALS

The main component symbols and their corresponding names in each drawing are as follows. The listed symbols are for illustrative purposes only and do not constitute a limitation on the scope of the present disclosure.
(100): Receiving action of Governance Initiation Command
(102): Generation of Initiation Identifier (including initiation hash value, segment identifier, step trigger flag)
(104): Generation of Structured Segmented Data from Input Data
(106): Acquisition of output from Non-Deterministic Processing System
(108): Encapsulation into Governance Archival Unit (linked to Initiation Identifier, including version identifier)
(200): Receive Input Data
(202): Generate canonical index
(204): Generate serialized indicator
(206): Establish segment index
(208): Merge indices and form Structured Segmented Data
(300): Obtain Initiation Identifier
(302): Directly adopt Initiation Identifier as Unified Trace Identifier
(304): Determination of executing cryptographic operation based on Initiation Identifier
(306): Generate Unified Trace Identifier
(400): Governance Archival Unit
(402): Unified Trace Identifier
(404): Structured Data (including canonical_input, serialized_input, input_index, etc.)
(406): NDP Output Data
(408): Governance Metadata (including step identifier, tool invocation, external event index, etc.)
(410): Cryptographic Proof (snapshot_hash/linkage proof)
(500): Obtain Governance Archival Unit data
(502): Calculate hash value
(504): Form hash link or generate Merkle root
(506): Generate Cryptographic Proof
(508): Write Cryptographic Proof into Governance Archival Unit
(600): Input and output of the first inference step
(602): Generate first Governance Archival Unit
(604): Input and output of the second inference step
(606): Generate second Governance Archival Unit (and link with Unified Trace Identifier)
(608): Input and output of the third inference step
(610): Generate third Governance Archival Unit
(612): Input and output of the fourth inference step
(614): Generate fourth Governance Archival Unit, forming a complete Multi-Step Inference Sequence
(700): Obtain Behavioral Outcome of Non-Deterministic Processing System
(702): Record successful output
(704): Record empty response
(706): Record abnormal output
(708): Record error state
(710): Record timeout state
(712): Record crash signal
(714): Encapsulate Behavioral Outcome into Governance Archival Unit
(716): Determine Termination State
(718): Record normal completion
(720): Record premature termination
(722): Record external interruption
(724): Record timeout termination
(726): Record incomplete status due to exception
(728): Encapsulate Termination State into Governance Archival Unit
(800): Multi-agent inference environment
(801): Planning agent
(802): Research agent
(803): Critique agent
(804): Summary agent
(810): Sequential Linking Information from planning to research
(812): Sequential Linking Information from research to critique
(814): Sequential Linking Information from critique to summary
(820): Output final inference result
(830): Input source
(840): Multi-agent governance archival process
(842): Governance Archival Unit of planning agent
(844): Governance Archival Unit of research agent
(846): Governance Archival Unit of critique agent
(848): Governance Archival Unit of summary agent

1. A governance record generation method for a Non-Deterministic Processing System, comprising:
(a) initiating a governance session or an equivalent governance processing period according to a Governance Initiation Command, and generating an Initiation Identifier to establish a starting tracking baseline for the governance processing period;
(b) receiving at least one Input Data, wherein the at least one Input Data comprises user input data, or data automatically generated by an application, an external event, or an agent program, and executing an Input Structuring Processing on the at least one Input Data without altering semantic content thereof to form at least one Structured Segmented Data, enabling the at least one Input Data to be consistently identified during subsequent governance verification;
(c) generating a persistent Unified Trace Identifier during the governance session based on the Initiation Identifier to serve as a unified linking identification baseline for cross-step governance data during a lifecycle of the governance session;
(d) encapsulating at least one governance data item into at least one Governance Archival Unit during the governance session, wherein the at least one governance data item comprises at least one of the at least one Structured Segmented Data, NDP Output Data of the Non-Deterministic Processing System or a Behavioral Outcome thereof, or corresponding Governance Metadata, and associating the at least one Governance Archival Unit with the Unified Trace Identifier via Cryptographic Linking, endowing the at least one Governance Archival Unit with verifiable immutability; and
(e) verifying a source, a role association, and immutability of the at least one Governance Archival Unit utilizing the Unified Trace Identifier during subsequent governance verification or behavioral replay to completely reconstruct an inference context.

2. The method of claim 1, wherein the Unified Trace Identifier directly adopts the Initiation Identifier or is a cryptographic derivation result based on the Initiation Identifier, to ensure that each governance data possesses consistent linkability and untamperability during the lifecycle of the governance session.

3. The method of claim 1, wherein the Input Structuring Processing comprises establishing at least one canonical index, a serialized indicator, or Governance Metadata for the at least one Input Data, enabling the at least one Input Data to undergo consistent comparison during subsequent governance verification or behavioral replay without altering original semantic content of the at least one Input Data.

4. The method of claim 1, wherein the Cryptographic Linking of the at least one Governance Archival Unit comprises calculating at least one hash value, a hash chain, or a Merkle root for internal encapsulated data thereof, and signing, verifying, or immutably storing a linked result to strengthen the immutability of the at least one Governance Archival Unit.

5. The method of claim 1, further comprising: continuously recording at least one Multi-Step Inference Sequence or decision sequence during the lifecycle of the governance session according to the Unified Trace Identifier, and encapsulating an input and an output of each decision step into a corresponding Governance Archival Unit, enabling an overall inference path of the governance session to be traceable.

6. The method of claim 5, wherein the corresponding Governance Archival Unit further comprises at least one Governance Metadata used to record external tool identification information, tool invocation parameters, an external sub-process identification, or an inference basis used in each decision step, to facilitate subsequent verification of behavioral establishment conditions of the decision step.

7. The method of claim 1, wherein the at least one Governance Archival Unit further encapsulates a Termination State of the governance session, wherein the Termination State comprises at least one of a normal completion, a premature termination, a timeout termination, an external interruption, or an incomplete status due to a system exception.

8. The method of claim 1, wherein the Behavioral Outcome comprises at least one of a successful output, an empty response, an abnormal output, an error state, a timeout state, or a crash signal.

9. A Non-Deterministic Processing System, comprising at least one processor and a memory, wherein the at least one processor is configured to execute the governance record generation method of any one of claims 1 to 8.

10. The system of claim 9, wherein the system is further configured to generate a Governance Archival Unit Data Structure, comprising:
(a) a Unified Trace Identifier field for providing a cross-step linking baseline for the Governance Archival Unit Data Structure during a lifecycle of a governance session;
(b) a Structured Input Data field for storing canonicalized user input data obtained through an Input Structuring Processing procedure without semantic alteration;
(c) an NDP Output Data field for storing NDP Output Data of at least one Non-Deterministic Processing System;
(d) a Governance Metadata field for recording step identification information, tool usage information, sub-process identification information, or other behavioral context data generated during the governance session; and
(e) a Cryptographic Proof field comprising one or more Cryptographic Linking proofs calculated based on data of the aforementioned fields to ensure that the Governance Archival Unit Data Structure possesses immutability and source verifiability during storage and verification.

11. A non-transitory computer-readable storage medium storing instructions that, when executed by a processor, cause the processor to execute the governance record generation method of any one of claims 1 to 8.

12. The method of claim 1, wherein a Multi-Step Inference Sequence of the governance session is executable by a plurality of Agent Models in a sequential or concurrent manner, and wherein an Agent Role Identifier, an input source, and Sequential Linking Information of each Agent Model are recorded in the at least one Governance Archival Unit to support inference path tracing of Multi-Agent Collaborative Inference.
